(19) United States
(12) Patent Application Publication
(10) Pub. No.: US 2006/0045964 A1
(43) Pub. Date: Mar. 2, 2006

(54) Processing method to treat glasses or the like surface

(76) Inventor: Tien-Shu Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/926,980

(22) Filed: Aug. 27, 2004

(51) Int. Cl. B05D 5/06

(52) U.S. Cl. 427/162

(57) ABSTRACT

A processing method to treat glasses or the like surface includes a transparent glasses having a first surface and a second surface. The first surface is applied with a hard coating by a spraying method. The second surface is applied with an anti-fog coating by a dipping method.

### BACKGROUND OF THE INVENTION

1. Field of the Invention

This invention relates to a surface treatment of glasses or the like, and more particularly to a transparent glasses made by a plastic injection has a first surface applied with a hard coating and a second surface applied with an anti-fog coating.

2. Description of the Prior Art

There are millions of glasses wearing by people at many different occasions, such as sunglasses, eyesight correction glasses and industry protection glasses. All of those glasses are made from plastic material, which are easy to collect steam and get scratches.

In order to correct the above-mentioned shortcomings, there are methods of applying hard coating and anti-fog coating on the glasses surface. However, the present techniques can apply only one membrane, either the hard coating or the anti-fog coating, thus, only one protection can be made to the glasses.

### SUMMARY OF THE INVENTION

It is the primary objective of the present invention to provide a processing method to treat glasses or the like surface, which provides the glasses with both steam and scratch protections.

It is another objective of the present invention to provide a processing method to treat glasses or the like surface, which glasses life lasts longer.

### BRIEF DESCRIPTION OF THE DRAWINGS

FIG. 1 is a side cross-sectional view of the present invention; and

FIG. 2 is a diagram showing the process of the present invention.

### DETAILED DESCRIPTION OF THE PREFERRED EMBODIMENT

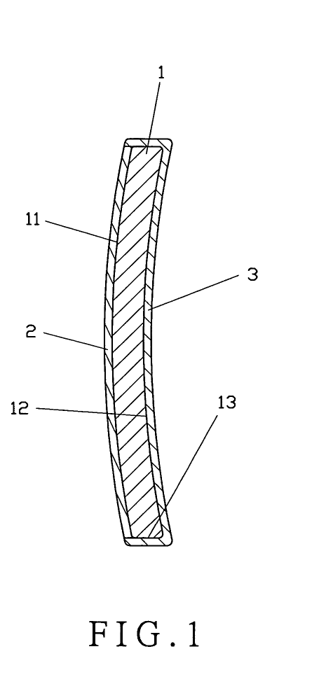

A processing method to treat the surfaces of transparent glasses 1 of the present invention is to apply a hard coating 2 on a first surface 11 of the glasses 1 and an anti-fog coating 3 on a second surface 12 of the glasses 1, whereas edges 13 between the first surface 11 and the second surface 12 are also applied with anti-fog coating 3, as shown in FIG. 1.

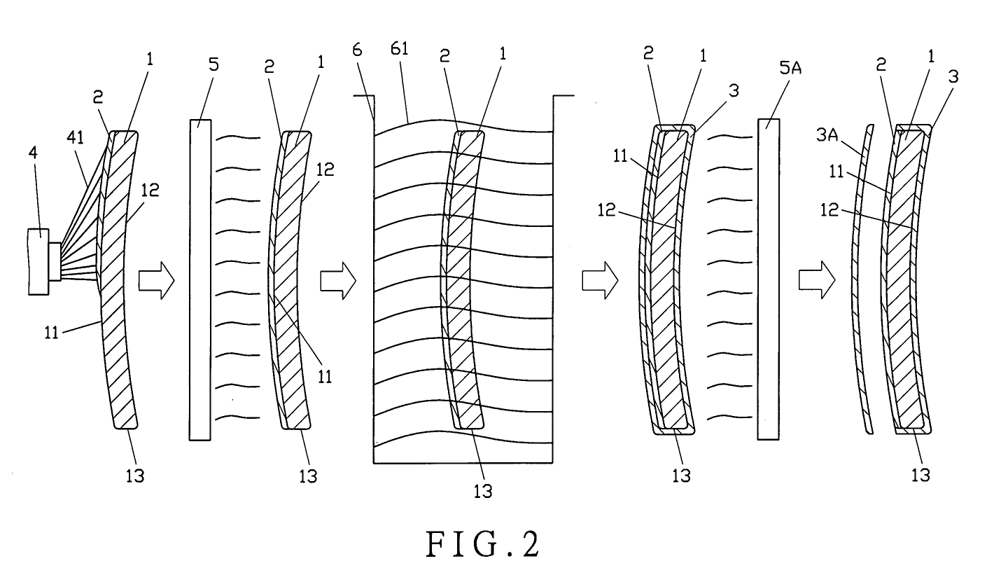

As shown in FIG. 2, a spray gun 4 is adapted to spray hard liquid 41 onto the first surface 11 of the glasses 1, then drying with a dryer 5 to form the hard coating 2. The entire glasses 1 is dipped into a container 6 filled with anti-fog liquid 61. The first surface 11, the hard coating 2, the second surface 12 and the edges 13 between the first and the second surfaces 11 and 12 are all dipped into anti-fog liquid 61. The glasses 1 is then lifted up and dried with a dryer 3A. The anti-fog layer 3A and anti-fog coating 3 are formed on the hard coating 2 of the first surface 11, the second surface 12 and the edges 13. Finally, the anti-fog layer 3A is removed from the hard coating 2 of the first surface 11. Only the second surface 12 and the edges 13 are applied with the anti-fog coating 3.

The hard liquid 41 may be polyurethane (PU) series as the main formula, and the anti-fog liquid 61 may be silicon liquid. Due to the non-compatible character of the two liquids, the first surface 11 is applied with the hard liquid 41 and the second surface 12 is dipped into the anti-fog liquid 61 so that the first surface 11 is only applied with the hard coating 2 and the rest surfaces of the glasses 1 are applied with the anti-fog coating 3.

I claim:

1. A processing method to treat glasses or the like surface comprising a transparent glasses having a first surface and a second surface, wherein said first surface is applied with a hard coating by a spraying method, and said second surface of said glasses is applied with an anti-fog coating by a dipping method.

2. The processing method to treat glasses or the like surface, as recited in claim 1, wherein edges between said first surface and said second surface are applied with anti-fog coating.

3. The processing method to treat glasses or the like surface, as recited in claim 1, wherein said glasses is applied with said hard coating on said first surface and the rest surfaces of said glasses are applied with said anti-fog coating.

4. The processing method to treat glasses or the like surface, as recited in claim 1, wherein said first surface of said glasses is applied with said hard coating by spraying with hard liquid and said glasses is then dipped into anti-fog liquid to form said anti-fog coating on all surfaces of said glasses, and lastly said anti-fog coating on said hard coating of said first surface is removed so that said first surface is only applied with said hard coating.

5. The processing method to treat glasses or the like surface, as recited in claim 2, wherein said first surface of said glasses is applied with said hard coating by spraying with hard liquid and said glasses is then dipped into anti-fog liquid to form said anti-fog coating on all surfaces of said glasses, and lastly said anti-fog coating on said hard coating of said first surface is removed so that said first surface is only applied with said hard coating.

6. The processing method to treat glasses or the like surface, as recited in claim 3, wherein said first surface of said glasses is applied with said hard coating by spraying with hard liquid and said glasses is then dipped into anti-fog liquid to form said anti-fog coating on all surfaces of said glasses, and lastly said anti-fog coating on said hard coating of said first surface is removed so that said first surface is only applied with said hard coating.

7. The processing method to treat glasses or the like surface, as recited in claim 4, wherein said hard liquid is polyurethane series as the main formula, and said anti-fog liquid is silicon liquid, due to the non-compatible character of said two liquids, said first surface is only applied with said hard coating and the rest surfaces of said glasses are applied with the anti-fog coating.

8. The processing method to treat glasses or the like surface, as recited in claim 5, wherein said hard liquid is polyurethane series as the main formula, and said anti-fog liquid is silicon liquid, due to the non-compatible character of said two liquids, said first surface is only applied with said hard coating and the rest surfaces of said glasses are applied with the anti-fog coating.

9. The processing method to treat glasses or the like surface, as recited in claim 6, wherein said hard liquid is polyurethane series as the main formula, and said anti-fog liquid is silicon liquid, due to the non-compatible character of said two liquids, said first surface is only applied with said hard coating and the rest surfaces of said glasses are applied with the anti-fog coating.
